(19) United States
(12) Patent Application Publication
(10) Pub. No.: US 2026/0330655 A1
(43) Pub. Date: Oct. 22, 2026

(54) Safeguarding a collaborative working zone

(71) Applicant: SICK AG, Waldkirch (DE)

(72) Inventors: Christoph HOFMANN, Waldkirch (DE); Michael SCHOTT, Waldkirch (DE); Heiko STEINKEMPER, Waldkirch (DE); Saiharan SOUNDARARAJAN, Waldkirch (DE)

(21) Appl. No.: 19/468,333

(22) Filed: Feb. 3, 2026

(30) Foreign Application Priority Data
Feb. 11, 2025 (EP) 25157074.3

(51) Int. Cl. G06T 7/246; G06Q 30/018; G06T 7/73; G06V 10/774; G06V 10/82; G06V 20/52; G06V 20/64; G06V 40/10; G06V 40/16

(52) U.S. Cl. CPC G06T 7/251; G06Q 30/018; G06T 7/75; G06V 10/774; G06V 10/82; G06V 20/52; G06V 20/64; G06V 40/107; G06V 40/16; G06T 2207/10024; G06T 2207/20081; G06T 2207/20084; G06T 2207/30196; G06T 2207/30232

(57) ABSTRACT

An apparatus for detecting a zone of a machine and for forming a protected field in the zone, said apparatus having at least one safety sensor and a control unit, wherein the control unit has a first and a second safety function and the first safety function is designed as a protected field adaptation and the second safety function is designed as an object tracking. The second safety function performs the object tracking of at least one person based on a body model differentiated by body model 3D landmarks, and the first safety function dynamically adapts a protected field based on data of the second safety function. The first safety function outputs a control command to a safety controller of the machine as soon as a body part of the body model enters the protected field.

The present invention relates to the field of safeguarding a collaborative human-machine working zone.

Collaborative robot systems can represent a solution when it comes to making it easier for a worker to carry out complex tasks, but at the same time they require a high level of safety to protect the worker from the machine due to the interaction between human and machine.

Collaborative applications are to be understood as applications in which humans and machines work directly next to or with one another without using further protective devices. The growing demand for human-robot collaborations requires technical rules so that reference is made by way of example to EN ISO 10218-1:2011 or ISO TS 15066:2016, which should not exclude or disregard analogous standards in other countries, for example.

In particular, three collaborative applications are of importance for the present application in order to ensure the safety of such systems. Firstly, a safety-monitored machine stop. In this case, the robot or the machine essentially works alone and the robot interrupts or stops the work as soon as a worker enters the working zone of the machine. The standstill lasts until the worker leaves the common working zone again. Secondly, a speed and distance monitoring. In this case, the distance between human and robot ids continuously monitored. If a prescribed distance is fallen below, the speed of the robot is reduced to a safety stop. In other words, the machine adapts its speed with respect to the position of the worker relative to the machine, i.e. to the distance between the machine and the worker in the common working zone, wherein three different safety distances (green, yellow and red) can be defined. A sensor system monitors the position of the worker in this respect. If the worker approaches the machine, the movement of the machine is slowed down. If the worker is too close to the machine, i.e. enters the red safety zone, the machine stops. Thirdly, a power and force limitation through inherent design and/or control. In this respect, the potential risk to humans from the robot is minimized by the limitation to dynamic parameters. For example, by monitoring forces and torques so that a use of the robot system takes place within a safety level acceptable to a worker in all foreseeable situations. In the following, these and further safety-relevant scenarios do not need to be sharply separated. It is important that a hazard is recognized with the aid of one sensor or more sensors and an associated evaluation and, if necessary, an appropriate safety response is derived therefrom to protect the health of persons according to a specified safety level.

In the present case, the term safety or safe use is to be interpreted within the meaning of safety standards such as ISO 15066:2016.

“Safe” and “safety” mean, as in the entire description, that measures are taken to control errors up to a specified safety level or to observe regulations of a relevant safety standard for machine safety or for electrosensitive protective equipment, of which some have been named in the introduction. Unsafe is the opposite of safe; the mentioned demands on fail-safeness are accordingly not satisfied for unsafe devices, transmission paths, evaluations and the like.

In the prior art, stationary or dynamically adaptable protected fields, protected zones or danger zones have so far been defined around the machine to safeguard collaborative applications and are monitored by a sensor system. For example, DE 10 2004 043 514 A1 describes the concept of dynamic protected field adaptation for a machine working in an automated manner. In this case, the protected field can e.g. be selected as larger when a person approaches the machine and as smaller when the person moves away from the machine. In this respect, a control unit is linked to the machine control in order to obtain the parameters required for defining the protected field. They are the future or immediate future position, direction of movement and/or speed of movement of the machine. With a simultaneous detection of the position, speed of movement and direction of movement of the person, this enables a dynamic adaptation of the protected field to the respective work situation.

A disadvantage of this is that a person cannot remain in the dangerous working zone of the robot arm while the robot arm is working, e.g. to monitor the work processes of the robot or to process a workpiece simultaneously with the robot.

It is further disadvantageous that the recognition is binary, i.e. an object is detected or not. For example, no object type (person, vehicle) or an object attribute derived therefrom (head, leg, hand) is transmitted so that it is not possible to dynamically adapt the protected field size in the working zone to the actual required protected field size.

WO2013135608A1 likewise relates to the safeguarding of a working zone of a machine working in an automated manner. For this purpose, a protected zone is defined in the working zone of the machine in a method step. A person is identified in the protected zone by a classifier and the identified person is then tracked via a person tracker over a series of 3D images. The person tracker determines a representative position of the person in the protected zone after each new 3D image. In one version, the person tracker can additionally comprise a body part detector. According to WO'608A1, this serves to determine a minimum distance between the person and the machine. In one embodiment of the method, the minimum distance is used to stop the machine if the identified person comes closer to the machine than determined by the minimum distance so that a kind of safety envelope around the machine can be minimized based thereon.

A disadvantage of WO'608A1 is that the person tracker is only designed to track one person so that, if a further person is present, no reliable conclusions for controlling the machines can be drawn from the classification and body part detection as such. Because if a person is, for example, concealed by a further person in the working zone of the machine so that only two left hands or a total of three hands are detected, it is not possible to draw conclusions about the further person and their position. The fail-safe position data of the foreign object detector are indeed compared with the position data, in particular the non-fail safe position data, of the person tracker, i.e. verified, in order to increase the safety; however, a machine stop, i.e. a differentiated safeguarding, is not possible if the position data do not match.

It is therefore an object of the invention to provide an apparatus and a method for safeguarding a collaborative working zone between a human and a machine.

This object is satisfied by the apparatus according to claim 1 and by the method according to claim 15.

The apparatus according to the invention for detecting a zone of a machine and for forming a protected field in the zone has at least one safety sensor, in particular a camera, in particular an RGBD camera, and a control unit, wherein the control unit comprises a first and a second safety function, wherein
the first safety function is designed as a protected field adaptation and the second safety function is designed as an object tracking,
characterized in that
the second safety function performs the object tracking of at least one person based on a body model differentiated by body model 3D landmarks, and
the first safety function dynamically adapts a protected field based on data of the second safety function, and
the first safety function generates a control command for monitoring the protected field and outputs said control command to a safety controller of the machine as soon as a body part of the body model enters the protected field.

In the present case, a zone of a machine is in particular to be understood as the collaborative working zone of the machine in which persons are regularly present. The persons can approach machine sections, in particular movable sections, in the zone, wherein the movable sections of the machine can have high accelerations to move quickly between different working positions.

A safety sensor is in the present case is to be understood as an optoelectronic sensor, a camera, an RGBD camera, a stereo camera, a lidar sensor and/or a radar sensor.

In the present case, a protected field is to be understood as a zone that in particular comprises the movable machine sections and that can be configured both two-dimensionally and three-dimensionally, e.g. as a volume running around the machine section. The spatial dimensions of the protected field, i.e. its spatial extent, can be dynamically adapted. The adaptation takes place based on data of the second safety function in the sense of a protected field adaptation.

The control unit has a first and a second safety function. A control unit can be understood as a data processing unit. However, the control unit is not limited to a single hardware component. Rather, the term control unit is to be interpreted functionally and comprises a series of hardware components that, in combination with one another, provide or implement the claimed functionalities of the first and second safety function. For this purpose, the control unit substantially comprises a first and second safe evaluation channel, which channels evaluate the data of the safety sensor and can substantially be assigned to the first or second safety function. The respective evaluation channels can exchange data with one another, i.e. transfer data, so that the first safety function dynamically adapts the protected field based on the data of the second safety function. For example, to implement the second safety function, the second evaluation channel transfers the position of the body parts determined by means of object tracking to the first evaluation channel that then serves to implement the first safety function. For example, to implement the first safety function, the first evaluation channel can determine, based on the transferred positions, that body part of the body parts which is spatially closest to a machine section. For this purpose, spatial distances D between the body part positions and the machine section are determined, for example. If one of the distances D falls below a permitted distance R predetermined for the respective body part, this corresponds to the entry of the body part into the protected field defined for the body part. A control command is then generated that e.g. triggers an emergency stop of the machine section. The body part therefore does not enter a spatially fixed, predefined protected field as was previously the case. Instead, the protected field is dynamic and depends on the body part as such and the position of this body part in relation to the machine. For example, the second safety function, in its design as an object tracking, determines the position of the body part at all times, i.e. preferably in real time. By monitoring the predefined minimum distance R, which is determined for the respective body part, the respective protected field and its monitoring then result in an implicit manner.

The control unit for dynamic adaptation and monitoring of the protected field preferably transmits the data of the second safety function to the first safety function in real time. The term real time characterizes the operation of the safety sensor or of the safety functions that are configured to reliably provide certain data, in the meaning of results, within a predetermined time period, e.g. in a fixed time grid, so that a dynamic adaptation of the protected field volume can take place in accordance with standards and so that a protected field is present at all times and safety is guaranteed at all times.

In the present case, the term “data” is to be understood as information that is used to implement the first and second safety functions. Depending on the type of safety sensor, data of the safety sensor can, for example, be available as image data or point clouds. The further data obtained by evaluating the image data are, for example, the number of persons in the working zone, the positions of the body parts, the distances D, etc.

The apparatus according to the invention has the advantage that the control command triggers a differentiated safety response of the machine. In other words, the safety response of the machine takes place in a differentiated manner, e.g. adapted to a specific body part. If, for example, a leg of a person is recognized in the working zone around the machine, it is sufficient to reduce the speed of a machine movement. In the case of the recognition of a hand in the safety zone of the machine, the machine movement would be stopped since a hand is a more sensitive body part. Further advantageously, the safety response of the machine can be adapted to the body posture of one person or several persons. If, for example, a worker bends their head to the front towards the machine, this would trigger an emergency stop. The apparatus according to the invention further allows the response of the machine to be adapted to the biomechanical properties of the relevant body part. For example, a force exertion of the machine can be reduced to the force exertion, which is allowed in the safety standard for the relevant body part, between the person and the machine as a safety response of the machine. The trajectory of the body part results directly from the continuous evaluation of the positions of the body part in space. A temporal differentiation of the trajectory provides the speed of movement of the body part with little computational effort. The distance R, i.e. the safety distance to be maintained, can, for example, be increased when the approach speed of the body part to the machine is high and can be correspondingly reduced when the approach speed is low. Alternatively, the safety distance R can be divided into a distance R1 and R2. Depending on which of the two safety distances R1 or R2 is fallen below, the safety response is then adapted thereto. In other words, a differentiation of the safety response of the machine can generally be based on the body part and/or on the approach speed of the body part. Countless additional differentiation options are conceivable. Since the working zone of the machine can be monitored in a differentiated manner, an unnecessary shutdown of the machine can be avoided. An interruption of the production process is less frequent.

In a particularly preferred embodiment, the data of the second safety function comprise spatial positions of the body parts, in particular of the body parts relevant for the safety application, of the at least one person.

In a further particularly preferred embodiment, the protected field is determined by a distance R permitted for a respective body part between the body part and a machine section, in particular a movable machine section. The permitted distance can be greater for a hand than e.g. for a head and can be regulated by EN ISO 10218-1:2011 or ISO TS 15066:2016, for example. The machine section does not have to be movable. The machine section can also be defined by a section of the machine that is e.g. characterized by a particularly high temperature. To prevent a burning of the respective body part, a greater distance would, for example, have to be predefined here for a hand than for a moving machine section. Therefore, the first safety function in particular also adapts the protected field based on an operating situation of the machine.

An apparatus according to any one of the preceding claims, having a housing, wherein the at least one safety sensor and the control unit are arranged within the housing.

In this advantageous embodiment, the apparatus can be configured as an edge device, whereby bottlenecks that could arise when transmitting larger amounts of data can be avoided and faster measures can be initiated based on the data. In principle, the apparatus can be implemented by positioning the at least one safety sensor at a specific position in the zone of the machine and forwarding the sensor data to a central control unit that can be configured as a central data processing unit. This is a preferred design in particular when using a plurality of safety sensors, in particular low-cost cameras.

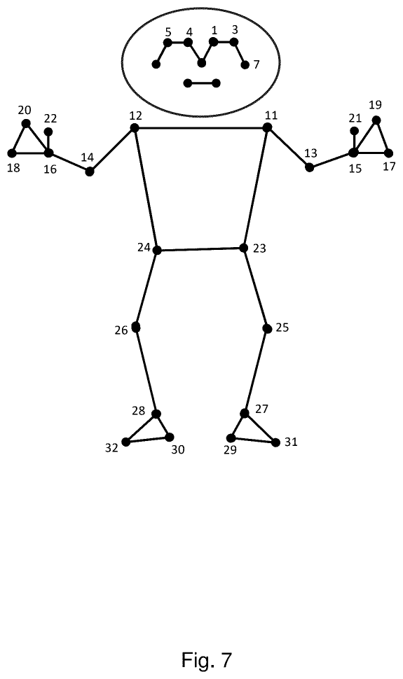

In the present case, a body model is to be understood as a body model that is differentiated for a specific safety application and that comprises the body parts relevant for the safety application. In the present case, a body part is to be understood as the section of a human body or animal body that can be morphologically and functionally delineated. These can be large body sections such as the head, trunk or limbs, but also parts thereof such as the nose, hand, fingers, eyes, etc. Such a body model defined for a safety application is specified in ISO/TS 15066:2016 (see FIG. 7), for example. The model differentiates between the front side and rear side of a person as well as between 29 different landmarks. Motion data (e.g. from motion capture systems) are used to set the model in motion. These data control the positions of the landmarks and make it possible to simulate realistic movements or to simulate realistic poses of a body part so that a further model trained to recognize a body part can be trained for the recognition of the 3D landmarks of the body model based on the poses that were simulated by the body model. In this case, the further model can be pre-trained for the recognition of the 3D landmarks and retrained within the meaning of transferring the existing training knowledge (transfer learning) to the body model 3D landmarks.

An apparatus according to any of the preceding claims, characterized in that the body model comprises body parts relevant for a safety application, and the second safety function has a processing chain that comprises models based on neural networks for recognizing 3D landmarks of body parts, wherein in each case at least one model of the processing chain is configured to recognize the 3D landmarks of a relevant body part, of the body parts relevant for the safety application, and at least one model is configured to recognize a body posture.

In the present case, a 3D landmark is to be understood as the three-dimensional spatial coordinates (XYZ) of a specific point, with which spatial coordinates the body model describes the position of a body part in space. Since it is not sufficient to recognize a body part by specifying a single 3D landmark or to describe the position of said body part in space, the body model comprises, for an unambiguous identification and position recognition of a specific body part in space, a predefined number of 3D landmarks for this body part that are located in a respective position relative to one another. In other words, depending on the pose or posture of the specific body part, the 3D landmarks form a pattern that is specific to the body part and that is recognized by a model, which uses the body model for body part recognition, on a predefined image by the model. For example, a hand can be described by twenty different 3D landmarks that are distributed along certain lines that run inside the palm and the fingers. The distances of the 3D landmarks from one another and the course of the lines along which the 3D landmarks are positioned change depending on the posture of the fingers. A model for hand recognition, which uses such a hand model as part of the defined body model, is trained based on predefined images, which comprise the hands, for example, of a worker, to recognize the specific pattern, which the 3D landmarks form with one another in different poses of the hand, on the predefined images with a certain probability. This can take place in a processing step that is downstream of the actual recognition of the hand as such. In other words, the neural network learns to link the extracted features of the body part with the positions of the landmarks. This often takes place by using heat maps that show the probability that a landmark is located at a certain position in the image.

In other words, the model for identifying and determining the spatial position of a body part comprises neural networks that are trained by means of training data to determine the body part on a predefined image and then to recognize the two-dimensional pattern of the 3D landmarks that is representative of the respective body part in a wide variety of poses of the body part on the image, and to calculate the spatial coordinates (XYZ) of the 3D landmarks resulting therefrom and then to output them for further processing.

The recognition of the body part is in this respect not based directly on the recognition of all the predefined 3D landmarks of the respective body part. If predefined 3D landmarks of a body part are not recognized, the prediction probability, with which the model specifies to have recognized a respective body part, deteriorates. The model transfers the recognized 3D landmarks of the body part and a value that indicates the prediction probability of the recognition, in other words, the extent to which the prediction of the model applies to reality, i.e. whether the recognized body part corresponds to the actual one and its actual position in space.

Landmarks are thus crucial for the precise recognition and analysis of movements, in particular in collaborative robot systems that must safely interact with humans. A model such as MediaPipe Hands from Google recognizes landmarks, i.e. specific points, on the hand, such as the joints of the fingers and the palm, that represent characteristic points that define the structure of the hand.

In one embodiment, those body parts which are to be recognized as relevant body parts for a respective safety application are preselected by a user of the apparatus. For example, the apparatus, in particular the control unit, comprises an input device so that the user can define relevant body parts via a provided graphical interface. For this purpose, a skeleton model of a person with the respective landmarks of the body parts is, for example, displayed on the graphical user interface. Using this representation, the user can, for example, mark desired body parts and their associated landmarks as relevant body parts with a mouse click and can thus adapt the defined body model to the safety application.

In the present case, a body part relevant for a safety application is to be regarded as a body part that, due to the use of the machine in the working zone, is exposed to a higher risk of injury as such than other body parts. For example, in a parts press, the hands of a worker, but also the respective fingers, represent relevant body parts since the worker places the part to be processed by the machine into the machine with their hands and removes it from the machine with their hands. As a result, in particular the hands or the fingers can be injured in the case of a malfunction of the machine. Thus, the legs would be regarded as body parts that are of little or no relevance for this specific application. In this case, a lower prediction probability for the recognition of the legs would be acceptable.

In the present case, a processing chain is to be understood as a sequence of processing steps in which the images of the safety sensor are processed in order to generate the control command and to output it to the safety controller of the machine for the control of the machine. The processing chain comprises the models based on neural networks (NN) for recognizing body parts by recognizing the 3D landmarks of the body model.

The at least one safety sensor detects the working zone of the machine and generates images. The image generation and provision takes place in the form of a continuous image sequence in the sense of a respective image frame as a respective single still image of a sequence of images that together form a video or an animation of the working zone. In this respect, the safety sensor is preferably implemented by an RGBD camera. An RGBD camera is to be understood as a Red, Green, Blue, Depth specialized camera sensor that captures both color information (RGB) and depth information (D) of a scene. The safety sensor captures the colors red, green and blue to create a complete color image of the working zone, which corresponds to the mode of operation of a conventional RGB camera. In addition to the color information, the safety sensor detects the depth, i.e. the distance between the camera and the objects, e.g. a robot arm, persons, etc., in the working zone. The safety sensor can determine the depth using various technologies such as time-of-flight (ToF), stereoscopic cameras or structured light projection. The RGBD safety sensor can combine the color information and the depth information on a pixel basis to provide a comprehensive image that shows both the color and the spatial depth of the objects in the working zone.

The body model comprises the 3D landmarks of the body parts as body model 3D landmarks. In this respect, the term body model 3D landmarks is to be differentiated from the 3D landmarks which are recognized by a model for recognizing a relevant body part, i.e. for which said model has been pre-trained, for example. To transfer the model predictions based on the 3D landmarks of the models to the body model 3D landmarks, the models can be retrained on the defined body model.

Advantageously, the positions of the relevant body parts are known to the safety controller of the machine at all times. This is to be understood as the recognition or position determination of the relevant body parts taking place within a time section in which the position of the machine or of the moving part of the machine is checked or monitored. A checking of the position of the machine e.g. takes place by a position encoder that monitors the position at regular intervals via a control loop. This time interval then e.g. comprises the time section within which the positions of the relevant body parts should be known.

The safety sensor transmits the image to the processing chain that comprises the models based on neural networks. The models configured for the recognition of 3D landmarks can each have different neural networks. For example, the neural networks are trained for the recognition of a relevant body part or a body posture by means of different training data and/or have different network architectures. If a relevant body part is recognized by a model, the model outputs transfer data that comprise the body part 3D landmarks of the relevant body part as spatial coordinates (X, Y, Z). In addition, the coordinates of a bounding box can be issued as part of the transfer data. The bounding box outlines the relevant body part so that the position of the relevant body part can be displayed in the image. The output of a bounding box is helpful, for example, for an application-specific retraining of the model in order to make the correct recognition of the relevant body part comprehensible. If the relevant body part is not recognized, corresponding information, e.g. left hand=false (H(L)=false), is output for further processing so that the transfer data of the model additionally comprise the information.

At least one model of the processing chain is configured to recognize the landmarks of a relevant body part, of the body parts relevant for the safety application of the at least one person in the working zone of the machine, and at least one model is configured to recognize a body posture or pose of the at least one person. In principle, the model for body part recognition forms a first detection channel in the processing chain within the second safety function and the model for pose recognition forms a further detection channel parallel thereto. Due to the recognized pose of the person, a kind of mapping rule is predefined by which it is defined where, for example, the arm or the foot of a person in a respective pose is located. If, for example, the position of an arm is known, the positions of the further recognized body parts in space can furthermore be checked with the aid of the recognized pose. In other words, the recognition of a body posture makes it possible that the positions of recognized body parts in relation to a respective person can be checked. It further applies that, due to the recognized 3D landmarks of the respective body parts as such, a position in space is assigned to the body parts so that the pose recognition can be regarded as a further, redundant detection channel. By combining both detection channels, it is advantageously possible to draw causal conclusions (if-then condition/rule) regarding the position of further body parts, in particular concealed body parts, from the body posture and the position of recognized body parts. Causal in particular means that a rule or an if-then condition can be formulated that links at least one position of recognized body parts with at least one further position of a body part in the sense of a mapping rule. The apparatus is thereby made more robust against a concealment or shadowing of body parts. It generally applies that the more detection channels in the form of models for recognizing body parts are used in the processing chain, the more causal conclusions in the sense of mapping rules can be derived therefrom and the more reliable the prediction reliability becomes overall.

The model for recognizing a relevant body part is configured to recognize the relevant body part even in the case of a plurality of persons. The model for recognizing the body posture is likewise configured for the recognition of the body posture of a plurality of persons in the working zone of the machine.

The body parts relevant for the safety application are recognized by models that are specifically trained, in particular pre-trained, for the recognition of the respective relevant body part and/or have a network architecture specifically configured for this purpose. A model, for example, has an architecture that can at least be divided into the following processing steps: pre-processing, recognition, prediction. In the following, the terms model and neural network are used synonymously unless a distinction is explicitly referenced.

Due to feature extraction of the visual features by the respective models, the 3D landmarks of the body parts relevant for the safety application are recognized in the image entered in step iii). The terms landmarks and 3D landmarks are used synonymously.

A possible architecture of feature extraction for recognizing landmarks of a specific body part, such as a hand, is given by a neural network configured as a Convolutional Neural Network (CNN). In an exemplary embodiment of a CNN, the input image is recorded in a first input layer, wherein the image is normally represented as a matrix of pixel values. In a second convolutional layer, a series of adaptive filters that glide over the entire image are used to recognize features such as edges, curves and textures in the image. In a third layer of the CNN, a non-linear function is applied to the image and sets all the negative values in the image to zero. Thus, a non-linearity can be introduced in the CNN and improves the performance and efficiency, i.e. the generalization capability of the CNN. In other words, the CNN is thus able to recognize complex patterns in an image and not only linear correlations between the input data and output data. A fourth pooling layer reduces the spatial size, i.e. the width and height of the input image. For example, the maximum or the average value of a respective image region can be used instead of the entire image region. This helps to reduce the number of parameters and to avoid overfitting, i.e. a deteriorated ability of the CNN to generalize. A fifth layer is the so-called fully connected layer. This layer connects each neuron of the previous layer with each neuron of the next layer. The fifth layer serves to combine and process the features extracted by the previous convolutional and pooling layers so that a final output layer serves to output the 3D coordinates of the recognized landmarks. These coordinates indicate the position of the landmarks in space and enable a reconstruction of the relevant body part, for example, the hand position and the hand posture. The neural networks of the respective models can differ in terms of the type and number of the layers, the filters used in a layer, etc.

Since the recognition of the relevant body part, such as a hand, is based on the determination of the landmarks of the hand and a body part typically has a plurality of landmarks, it is not necessary to recognize all the landmarks. In other words, even if, for example, a number of fingers on a hand are not recognized because they are covered, a hand can be concluded with a certain probability.

The architecture described is a simplified representation of a CNN architecture, wherein the basic principle also remains valid for more complex CNN architectures. The principle is that a convolutional layer, a non-linearization layer and, if necessary, a pooling layer serve to extract features of the relevant body parts from the images and to assign them to the relevant body part as a representative feature by means of the fully connected layer. A feature extraction can in particular also take place via a plurality of CNNs. For example, a first CNN can be optimized for the recognition of a palm and a subsequent, second CNN for the recognition of the further 3D landmarks of the fingers adjoining the palm. By means of the image region of the first CNN provided by the palm recognition, the recognition of the fingers is efficiently limited to the image region predefined by the palms.

Within the processing chain, at least one CNN is therefore used to recognize a relevant body part. Thus, in the processing chain, the CNNs are preferably responsible independently of one another for the recognition of that relevant body part for which the CNN was trained. The respective CNNs are, for example, trained, in particular pre-trained, for the recognition of landmarks of a hand, a face or an arm.

One possible CNN for recognizing hand landmarks is the “Media Pipe Hands” model from Google. In this model, the architecture has a “palm detector” as a first CNN that is specifically optimized for the recognition of palms. A further CNN uses the image sections that are transmitted by the palm detector and that have the palms to identify the specific landmarks of a respective hand and to calculate and output their 3D coordinates. The architecture of the “MediaPipe Hands” model is advantageously optimized so that a hand recognition can be performed on mobile GPUs (Graphics Processing Units) in real time, whereby a fast and efficient hand tracking within the second safety function is possible so that the hand position relevant for the safety application is known at all times.

Accordingly, one possible CNN for recognizing a face is the “Media Pipe Face” model from Google. In this model, the architecture has a “BlazeFace detector” as a first CNN that is specially optimized for the recognition of faces and thereby differs directly from the model for hand recognition. A further CNN “Face Mesh” enhances facial recognition by recognizing 468 3D landmark points on the face and enabling a detailed modeling of the facial geometry and the facial orientation in real time. In other words, the architecture of the “MediaPipe Face” model is also advantageously optimized so that it can run in real time on mobile GPUs, such as those provided by NVIDIA, whereby a fast and efficient hand tracking within the second safety function is likewise possible so that the hand position relevant for the safety application is known at all times with respect to a position of the machine.

One possible CNN for recognizing a body posture or a pose is “BlazePose” from Google. “BlazePose” is a model for a real-time body posture recognition that is specifically optimized for mobile devices and therefore requires little computing capacity. It is trained to recognize 33 2D landmarks of the human body from a single image frame. In a first step, palms are recognized in the image frame. This takes place via a neural network that is trained for the recognition of palms. As soon as the palms have been recognized, a rectangular region around each palm is defined and is used as an input for the next neural network within “BlazePose”. The next neural network in the “BlazePose” processing chain is specifically trained to recognize the positions of joints and limbs in the form of 3D landmarks. In a further, subsequent neural network, the body posture is estimated by means of the transferred 3D landmarks by calculating said body posture from the positions and angles of the different body parts relative to one another.

Alternatively, the PoseNet model can also be used. PoseNet has a CNN that extracts those features from the input image which contain important information about the structure and the appearance of the persons contained in the image. In this respect, PoseNet estimates, by means of a regression, the x and y coordinates of the joints in the image or predicts them. The model can in this respect output the estimated positions of the most important body joints, such as shoulders, elbows, wrists, hips, knees and ankles. These coordinates can then be used to reconstruct the pose or body posture of the person. PoseNet provides a fast and efficient pose recognition so that the body posture of one or more persons that is relevant for the safety application, together with the positions of the relevant body parts, is known at all times.

The control command that is output to a safety controller of the machine is thus based on the recognition of the body parts relevant for the safety application and/or on the recognition of the body posture of the at least one person.

The body parts relevant for the safety application should in particular be known to the safety controller of the machine at all times so that, depending on the position of the relevant body parts, the machine can be brought to a specific operating mode in the sense of a safety response by the safety controller. A safety response therefore comprises different operating modes in the sense of different collaborative applications between human and machine. For example, depending on the distance of a relevant body part, the safety-monitored machine stop can cause a reduction in the speed of the machine movement or a power and force limitation.

In a particularly preferred embodiment, the 3D landmarks of body parts that are recognized by the models are associated with the body model 3D landmarks of the relevant body parts and are transferred as transfer data to a data link module of the processing chain.

In the embodiment, the processing chain comprises the data link module. The association of the 3D landmarks with the body model 3D landmarks can take place by retraining the model. This process is designated as transfer learning. In this respect, the models used in the processing chain are already trained on a large data set and are good at recognizing general features. In a fine-tuning, the pre-trained model is then further trained on the new data set with the specific body model 3D landmarks of the new, defined body model. This requires less data and computing power than the basic training of a model. Often, only the last layers of the neural network are adapted in this respect, while the earlier layers, which extract general features, remain unchanged. This enables the model to learn specific details of the new, defined body model while retaining the general features already learned. After the fine-tuning, the model is evaluated and further optimized to ensure that it accurately recognizes the new landmarks.

In an alternative embodiment, the 3D landmarks already comprise the body model 3D landmarks and/or can substantially be derived therefrom, for example analytically.

Further alternatively, a linking of the 3D landmarks with the body model 3D landmarks can take place via a further neural network. For example, the further neural network can be trained to conclude the body part 3D landmarks based on the 3D landmarks of a pose that was recognized by the model for recognizing the body posture. For this purpose, the positions of the body model 3D landmarks of the defined body model are changed by the neural network until the pose is replicated. In other words, the further neural network learns how the defined body model must be adapted to a respective pose.

In one embodiment, the body model 3D landmarks of the transfer data are checked for plausibility and completeness based on the body model by means of a data link of the data link module. Based on the checked body model 3D landmarks, body model 3D landmarks of the body model that are not recognized by the models are concluded in order to complete the recognition of the body model 3D landmarks of the body model.

The pose of the person is like a mapping rule by which it is defined where, for example, the arm or the foot of a person is located and which thus links the positions of the respective recognized further body parts with one another in space.

Since the checking is based on the recognized body model 3D landmarks and not on image data, the embodiment offers the advantage that the recognition is more robust against occlusions since a relevant body part is still recognized even though it is partly occluded in the image, for example. This is because the body model prescribes how the body parts must generally be arranged relative to one another. For example, in which position a left or right arm must be. Such a spatial landmark mapping rule would be, for example, that, in addition to a recognized landmark, further adjacent landmarks must be present at a distance predefined by the body model. A logical landmark mapping rule would be, for example, that if the landmarks of a right hand are present and the body model has defined a left and right hand, the landmarks of the left hand must in principle also be present. Based on such relations or mapping rules, the body model 3D landmarks are linked with one another based on rules derived from the body model in order to check the transfer data for plausibility and completeness. Since countless different rules can be derived from the body model, only a few of the possible rules will be described as examples.

A negative rule would be that a hanging right hand is determined based on the positions of the landmarks. However, a hanging hand cannot intervene in the machine because it would have to be stretched out, for example. Consequently, according to this rule, no safety response of the machine would be triggered even though the hand is close to the machine. Furthermore, a person cannot have two right hands so that, if two right hands are recognized, a further person must be present.

An environment rule would be that the body parts predefined in the body model must also be recognized, wherein a hand recognition model possibly only recognizes a left hand. In this case, the landmarks of the further models are used to deduce the position of the hand. For example, from the pose of the person, i.e. with the model for recognizing the body posture. The position of the hand can be concluded from the positions of the arms. A further example of an environment rule would be that, from a recognized landmark, the further landmarks immediately adjacent to the recognized one are concluded in the sense of a neighborhood relation. If an ankle is recognized, the further landmarks of the foot should also be recognized. In this respect, the body model specifies the distance within which an adjacent landmark is to be expected so that the position of the expected landmark must be on a flank with the radius R around the recognized landmark. Based on this, a safety response can take place if the adjacent landmark is not recognized.

The rules advantageously consider the probability of the prediction of a model. A respective model calculates a confidence value (confidence score) for each 3D landmark that is output with the transfer data. The confidence value describes how certain the X, Y, Z spatial coordinates of a landmark predicted by the model for the relevant body part actually are. If, for example, two left hands are recognized with a high confidence value in a first case, but only one right hand, a logical AND operation of the transfer data of the data reveals that the result of the recognition is not plausible because a further right hand is missing. However, if in another case the recognition of the second left hand had a low confidence value, the second left hand could be a false recognition. To substantially rule out a false recognition, in one embodiment, a threshold value is defined, e.g. a value between 0(0 %) and 1 (100%), from which a relevant body part is considered to be “reliably recognized”, for example, if the confidence value is greater than the predefined threshold value of e.g. 0.75. In this example, it is assumed in a simplified manner for the sake of illustration that all the body parts are within the detection zone of the camera.

In a preferred embodiment, in a first link, the transfer data of the respective at least one model configured to recognize 3D landmarks of a relevant body part are linked to one another within the respective model and, in a second link, the transfer data of the respective models configured to recognize 3D landmarks of the relevant body parts are linked to one another across the models.

The check is thereby structured to prevent incorrect transfer data of the respective models from being taken over in the further second link that is subsequently performed. Extending the plausibility check to all the transfer data of the models increases the reliability of the model prediction overall. For example, the recognition of a left hand is validated by the model for hand recognition in the first link. A validation of the assignment of the hand to one of the persons in the working zone only takes place in the second link.

In one embodiment, the model for recognizing the body posture is configured to also at least partly recognize the body model 3D landmarks of the body parts relevant for the safety application.

This has the advantage that, of the landmarks of the pose recognition, at least one landmark of the relevant body part can always be checked. The results of the models can thus be assigned more easily to a respective person.

A body part, of the relevant body parts, that is relevant for the safety application, is further preferably recognized by a respective one model. This has the advantage that a respective model is trained very specifically for the recognition of exactly this body part and the prediction reliability is therefore increased compared to models that are trained for the recognition of a plurality of body parts since the latter models have to consider a wide range of features and variations, which increases their complexity, leads to lower confidence values and requires a higher computing power, which in turn disadvantageously reduces the prediction speed in the present case.

In one embodiment, at least one model of the models is configured to differentiate between a front side and rear side of a person based on the body model. This additional differentiation is preferably implemented by a model for facial recognition. This advantageously makes it possible that a walking direction or direction of movement of the person in the working zone can be determined by the linking of the transfer data of the model for facial recognition with the model for recognizing the body posture. Based on whether the person is moving towards or away from the machine, the safety response of the machine is adapted in a differentiated manner. Such a model can be based on TS 15066.

In one embodiment, at least one model of the models is configured, based on the body model, to recognize hands as relevant body parts of the body parts relevant for the safety application, and at least one model is configured to recognize faces as relevant body parts of the body parts relevant for the safety application.

In one embodiment, at least one model of the models is configured to delineate a zone, in the input image, of the at least one person as a person zone. The model is preferably configured as a model for person recognition. The model for recognizing the body posture can comprise the model for person recognition. The model for person recognition is upstream of the further models of the processing chain by dividing the image entered into the processing chain into person zones and transferring them to the further models of the processing chain for recognizing the body parts of the persons. The image processing is thus advantageously limited to a smaller data set of the person zones, which reduces the computing time and the computing effort.

One possible model for person recognition is “OWL-ViT”. “OWL-ViT” does not use a CNN, but is based on a vision transformer. Transformer models use mechanisms of self-awareness to understand the relationships between different parts of the input data. This enables the model to extract relevant information from the entire input context. The transformer architecture enables OWL-ViT to work with image-text pairs and to recognize objects in images that are not explicitly included in the training data set. This has the advantage that, with the model, the recognition of a specific body part can be intentionally queried if, for example, the other models could not recognize the body part.

In one embodiment, the differentiated body model comprises anthropometric data, in particular of the relevant body parts, in particular according to DIN 33402-2:2005-12.

This has the advantage that the body model additionally allows a dimensioning of the actual distances between landmarks. Thus, the distance defined by the body model between landmarks, in particular adjacent landmarks, can be used as a rule for checking a respective pose and respective body parts.

In one embodiment, a contact type between the relevant body part, of the body parts of the person that are relevant for the safety application, and the machine is concluded from a depth information of the RGBD camera.

In this embodiment, the depth information, i.e. the distances of objects from the safety sensor, is provided in the form of a depth image. Such a depth image graphically depicts the course of the distances of objects, body parts, etc. from the safety sensor. For example, darker regions are further away from the safety sensor, while brighter regions are closer to the safety sensor. If, for example, a hand is shown as a bright image region that extends within a darker region that represents a robot arm, the hand is positioned in front of the robot arm from the perspective of the safety sensor, i.e. closer to the safety sensor. In other words, the hand does not contact the robot arm at the time of the recording and the contact type would be classified as “non-contact”. In this respect, different safety sensors can generate different depth images from their respective perspectives so that, for example, a contact between a body part is recognized as no contact from a further, different perspective. Thus, the respective contact types can be validated.

The contact type is preferably implemented in that the course of the depth information in the edge region of respective regions represents the body parts, objects, etc. with which image regions adjoining these image regions are analyzed. If the result of the analysis is that the depth information in the edge regions transitions continuously, evenly or smoothly into the adjacent image region(s), it is a contact type that is to be classified as “contacting or static”. In such a case, the hand, for example, rests on the object or the machine part. If the result of the analysis is that the depth information transitions discontinuously, abruptly or unevenly into the adjacent image region(s), it is a contact type that is to be classified as “non-contact or transient”.

In the present embodiment, a contour is to be understood as the edge region which is surrounded by a respective object, body part, etc. and by which the object, body part, etc. appears delineated in its shape from other regions. The contour can in this respect extend to the transition region between adjacent objects so that the contour at least partly comprises edge regions of respective adjacent objects in order to enable an analysis of the course of the depth information in these regions.

Based on the contact type, the safety response of the machine can be adapted in a further differentiated manner according to the standard.

In a particularly preferred embodiment, the models for recognizing a relevant body part of the body parts relevant for the safety application are pre-trained and the selection of further training data after the deployment of the models is representative of the specific application in which the apparatus is used. Deployment in the present case is to be understood as the process in which the respective trained models are transferred to the application-specific environment in order to process the real data supplied by the safety sensor and to make predictions in the sense of a body part recognition or body posture recognition. By using pre-trained models as a starting point, the apparatus can be quickly trained for the customer-specific application.

In a further preferred embodiment, the training data comprise application-specific RGBD image data of the machine during the operation of the machine. Thus, the apparatus can be quickly trained for the specific application of the machine. A specific application can, for example, be formed by a specific movement sequence of a robot arm in which a worker is partly covered by the robot arm in the safety zone of the robot arm.

In a further preferred embodiment, the training data comprise customer-specific RGBD image data of the machine in different customer-specific working zones. Thus, the apparatus can be quickly trained for a customer-specific application in a customer-specific environment. A customer-specific environment can, for example, be formed by certain lighting conditions under which a robot arm moves. This leads to a low contrast ratio between the robot arm and the worker, whereby a body part recognition can be made more difficult.

In a particularly preferred embodiment, the body parts relevant for the safety application comprise hands, fingers, forearms, upper arms, legs, head and torso.

In a particularly preferred embodiment, at least two safety sensors, in particular RGBD cameras, provide a respective image of the working zone of the machine, in particular from different perspectives of the working zone. This has the advantage that a covered body part can be recognizable for a model at least on one of the images of the images recorded from the different perspectives, in particular if there are a plurality of persons in the working zone of the machine. If a covering is less likely, the certainty of the model predictions increases, i.e. the certainty with which relevant body parts are recognized. The cameras are for this purpose positioned at different spatial points in the working zone such that, from the viewing angles of the cameras, a covering of a body part of a person by the machine or other objects in the working zone is minimized. The images recorded from the different viewing angles of the safety sensors are calibrated to a common coordinate system of the working zone. The calibration can take place via static objects (optical markings). Alternatively, the floor of the working zone of the machine can be used as a reference for the calibration. Due to the calibration, the coordinate systems of the images recorded from the different perspectives are substantially the same.

The number of persons in the working zone can be derived from the number of recognized relevant body parts and/or also from the model for recognizing the body posture. Alternatively thereto, the number of persons can also generally originate as a transfer parameter from the further model, which is in particular upstream of the recognition, for example, from the person recognition model described.

The invention further relates to a method for safeguarding a machine, comprising the following steps:
detecting a zone of the machine by means of at least one safety sensor, in particular a camera, in particular an RGBD camera;
forming a protected field in the zone in that a control unit performs a protected field adaptation as a first safety function and performs an object tracking as a second safety function, wherein
the second safety function performs the object tracking of at least one person based on a body model differentiated by body model 3D landmarks, and
the first safety function dynamically adapts the protected field based on data of the second safety function, and
the first safety function generates a control command for monitoring the protected field and outputs said control command to a safety controller of the machine as soon as a relevant body part enters the protected field.

Further preferred embodiments of the apparatus and the method can be seen from the following description of the embodiment examples in connection with the Figures and their description. Identical components or method steps are substantially identified by identical reference signs, unless otherwise described or unless otherwise apparent from the context.

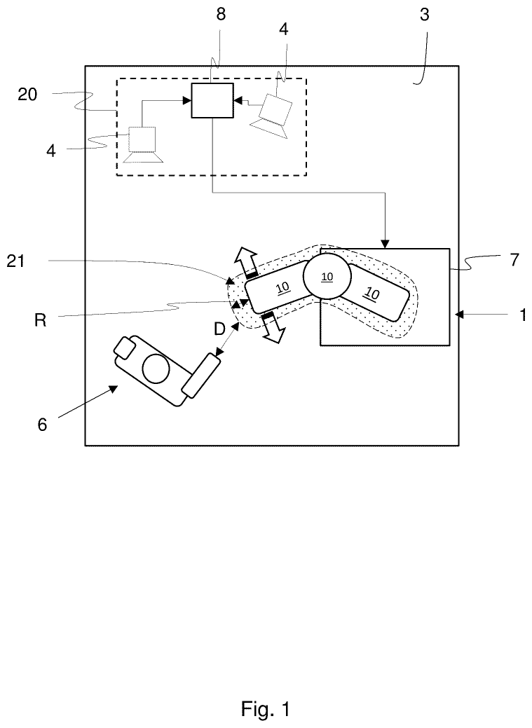

FIG. 1 shows a schematic representation of the apparatus in a working zone of a machine from a bird's eye view together with a person in the working zone.

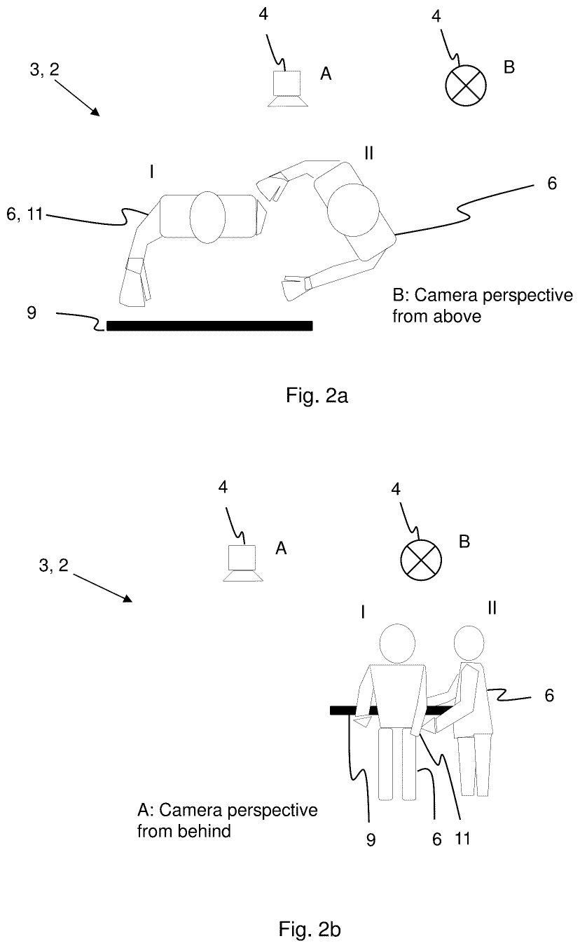

FIG. 2a shows a schematic representation of a working zone from a bird's eye view of a safety sensor (A). A machine, two persons and an object are located in the working zone.

FIG. 2b shows a further schematic representation of the working zone of the machine from FIG. 2a from the side perspective of a further safety sensor (B).

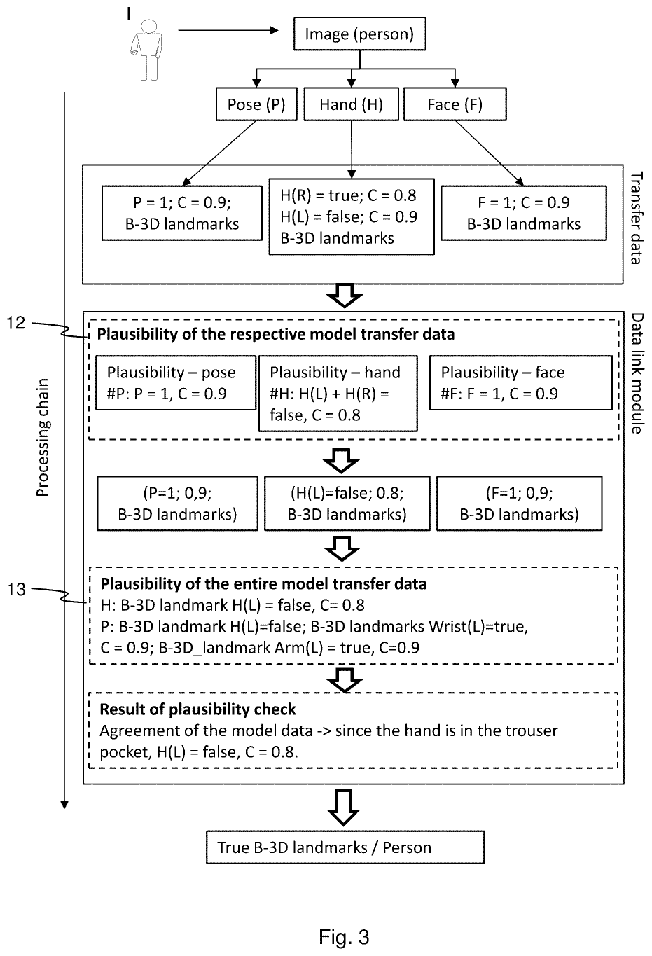

FIG. 3 schematically shows the processing chain with the associated sequences.

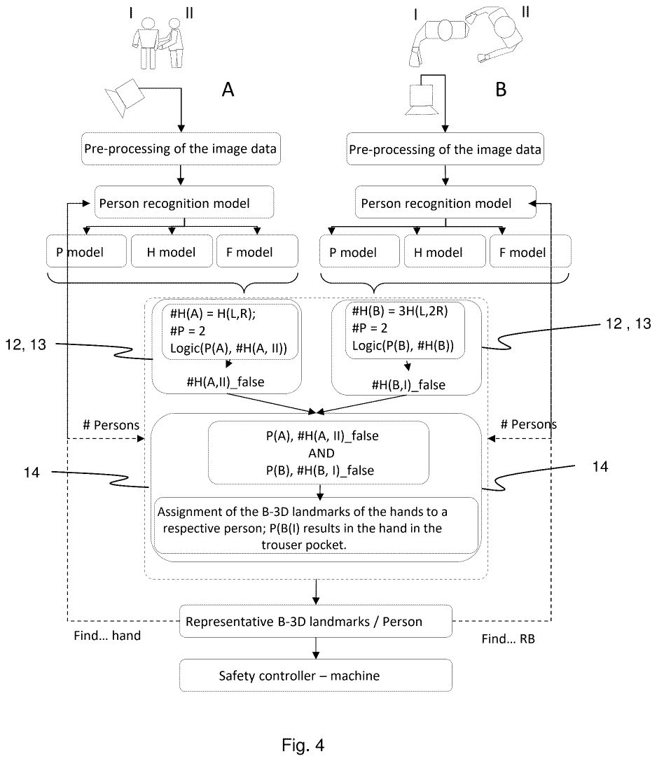

FIG. 4 shows the processing chain and the associated sequences in the embodiment of the apparatus with two safety sensors from different viewing angles in each case, wherein the safety sensors detect two persons in the working zone of a machine.

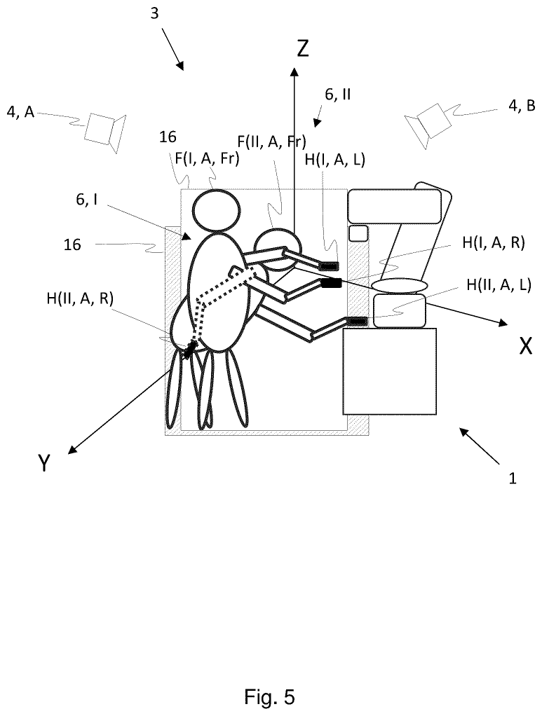

FIG. 5 shows, from a side view, the working zone of a machine with two persons.

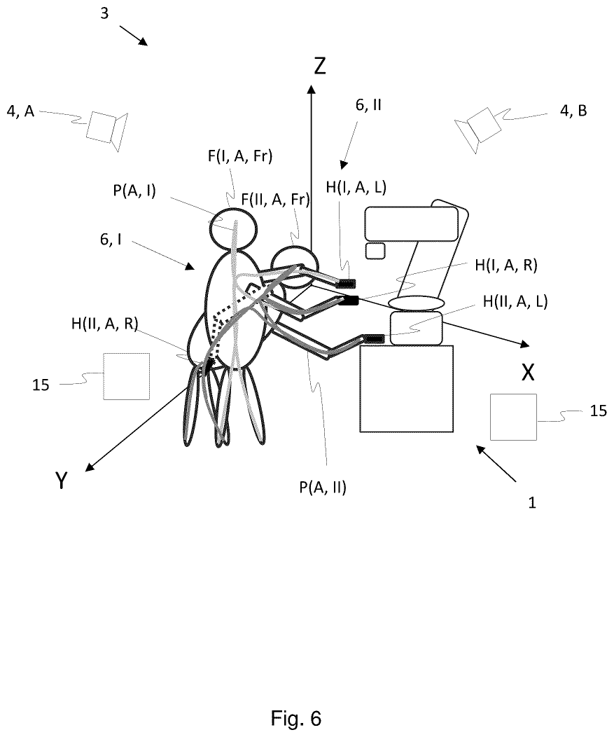

FIG. 6 shows the side view shown in FIG. 5, wherein the poses of the persons are sketched, and indeed, for example, as they were recognized by the model for recognizing a body posture.

FIG. 7 shows a body model defined for a safety application.

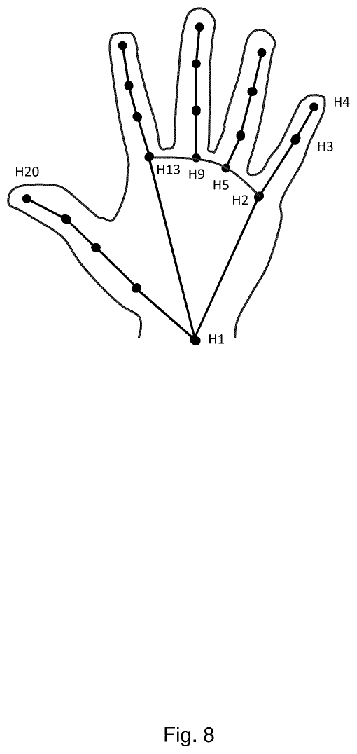

FIG. 8 shows the 3D landmarks H1-H20 of a left hand that are recognized by the model for hand recognition to determine the position of the hand in space.

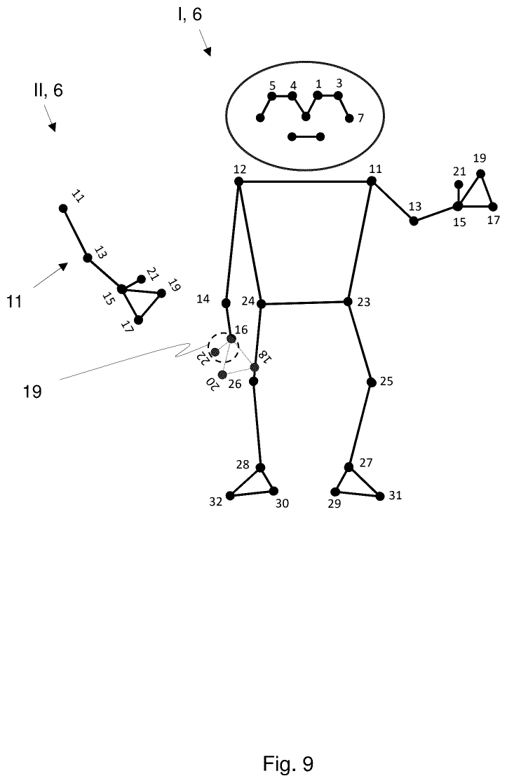

FIG. 9 shows the body model of a first person determined from the body model 3D landmarks of the transfer data and that of a left arm of a second person.

A schematic representation of the working zone 3 of the machine 1 is shown from a bird's eye view with a safety controller 7 in FIG. 1. A person 6 is likewise shown in the working zone 3. In the embodiment shown in FIG. 1, the apparatus 20 comprises two safety sensors 4 and is configured as an edge device, which is supposed to be indicated by the dashed line surrounding the apparatus 20. The control unit 8 is substantially configured as a data processing unit (DPU). A DPU is to be understood as a specialized hardware device or a software framework that is designed for the processing of at least one pre-trained neural network. The data processing unit can, for example, be an NPU (Neural Processing Unit), which is specifically designed for accelerating AI learning tasks, a GPU (Graphics Processing Unit), a VPU (Vision Processing Unit), which is optimized for processing visual data, or a TPU (Tensor Processing Unit) that is specifically optimized for accelerating AI tasks, in particular for working with Tensor Flow models. The data processing unit is capable of further training the models of the processing chain in an application-specific manner. In this case, the edge device has sufficient computing power to fine-tune a respective model after the deployment of the models. The training of the models can be successively performed. The DPU is therefore specifically designed such that it offers a high computing power with a low energy consumption. Furthermore, the DPU is preferably small and lightweight so that it fits into the housing of the edge device, which may require the integration into a small form factor, e.g. a system-on-chip. The DPU enables the processing of image and video data in real time and can load and execute the models of the processing chain, whereby the implementation time is shortened and the implementation is simplified. By processing the data directly on the edge device, the latency is advantageously reduced and the necessity of sending large amounts of data to central servers is minimized. An example of such a DPU in the version as a GPU is the NVIDIA Jetson Orin.

A moving machine part 10 of the machine 1 can move to the left and the right in the working zone 3, which is supposed to be indicated by the respective arrows in FIG. 1. The person 6 approaches the moving machine part 10. In this respect, the person 6 stretches their right arm 11 towards the moving machine part 10 so that said arms are fundamentally endangered by the movement of the machine part 10 and therefore represent body parts that are relevant for the use of the machine 1. The safety sensors 4 generate images of the working zone 3 at regular intervals, said images showing the person 6 and in particular the moving machine part 10. The respective images recorded by the RGBD camera of the safety sensors 4 are read in and processed in the data processing unit of the control unit 8. The processing of the read-in images comprises the body part recognition and body posture recognition of the person 6 by the respective models of the processing chain. Based on the recognition of the arms 11 and the body posture of the person 6, the spatial position of the right arm 11 and the position of the machine part 10 are determined. The distance D between the machine part 10 and the right arm 11 is determined. It results from this that, of all the relevant body parts, the right arm 11 has the shortest distance D from the machine part 10. The permitted distance R predetermined for an arm 11, in the sense of a safety distance, may thus not be fallen below. The distance R so-to-say defines a protected field 21 that is formed in a volume-like manner around the machine part 10. If the spatial distance D becomes smaller than the volume 21 predefined by R, the arm 11 enters into the protected field volume 21. In such a case, the control unit 8 of the apparatus 20 outputs a control command to the safety controller 7 of the machine 1. The control command triggers a safety response of the machine 1. For example, an emergency stop is triggered if one or both arms 11 of the person 6 enter the protected field 21. The safety response takes place in a differentiated manner. This means that, due to the continuous evaluation of the position of the arm 11, the trajectory of the arm 11 in space results, from which the speed of movement of the arm 11 can be deduced with little computational effort by means of a temporal differentiation. Thus, the distance R, i.e. the safety distance to be maintained, can be increased when the approach speed of the arm 11 is high and can be reduced when the approach speed of the arm 11 is low. Alternatively, the safety distance R can be divided into a distance R1 and R2. Depending on which of the two safety distances R1 or R2 is fallen below, the safety response is then adapted thereto. In other words, a differentiation of the safety response of the machine 1 can generally be based on the body part and/or the approach speed of the body part. Countless additional differentiation options are conceivable.

In FIG. 2a, a further schematic representation of the working zone 3 of the machine 1 is shown, wherein, in this embodiment, two persons (I, II) 6 are located in front of an object 9. The scene should correspond to the image 2 that is provided by a safety sensor 4 looking at the working zone 3 from a bird's eye view (A). In this respect, the person I stretches their right arm 11 towards the object 9, while their left arm extends along their body. In this orientation of the person I relative to the safety sensor 4, a left hand would thus not be recognizable. In contrast, the left and the right hand of the further person II are arranged in the working zone 3 such that they are recognizable from the image 2 for a model for hand recognition.

The schematic view of the working zone 3 of the machine 1 that us shown in FIG. 2a is shown in FIG. 2b. The scene should correspond to the image 2 that is formed by a further safety sensor 4 looking at the working zone 3 from the side perspective (B). In this side view (B), the arm 11 of the person I can be recognized in the image 2, but not the hand of the person I. Furthermore, the right hand of the person II is obscured by the object 9 from this side perspective (B) and likewise cannot be recognized from the image 2 by the hand recognition model. If the transfer data of the models from the respective perspectives (A, B) of the safety sensors 4 are linked together, a plausible position of the hands results. In this case, the right hand of the person I is e.g. in their trouser pocket, which can be seen from the position of the arm 11, i.e. the recognized 3D landmarks of the arm 11, in FIG. 2b. The position of the right hand of the person II, which is concealed in FIG. 2b, can be determined from the perspective B of the further safety sensor 4.

FIG. 3 schematically shows the processing chain with the associated sequences. First, the image 2 of the working zone 3, which shows the person 6, is entered into the processing chain. In this embodiment, the processing chain comprises four detection channels. A model for hand recognition (H model), a model for facial recognition (F model) and a model for recognizing the body posture (P model). On the input image 2, the models recognize the respective relevant body parts on which they have been trained. The recognition and non-recognition of the body parts or the body posture takes place with a certain probability that is included by the confidence value (C) in the transfer data in addition to the 3D landmarks of the recognized body parts. In the present case, the hand recognition model recognizes a left (L) hand with a certainty of 90%, but not a right hand with a certainty of 80%. The 3D landmarks of the body posture and those of the face are each recognized with a 90% certainty. The transfer data are transferred to the data link module that is schematically shown in FIG. 3 outlined by a box. Before transferring the transfer data, the transfer data are generated by assigning the 3D landmarks of body parts to the body model 3D landmarks. The assignment can take place by a further neural network of the processing chain that is trained to project the 3D landmarks of a respective model onto the body model 3D landmarks or to assign them thereto. Alternatively, this step can be sufficiently implemented by retraining the existing models on the defined body model in the sense of “transfer learning”. In the embodiment shown in FIG. 3, the assignment took place by means of transfer learning so that the generation of the transfer data is not shown as a separate step in FIG. 3.

Within the data link module, further steps are indicated hatched by respective boxes. The links are based on rules or mapping rules derived from the body model. These rules can comprise the distance of a recognized landmark from a next or directly adjacent recognized or non-recognized landmark or the assignment of a body part to a respective person.

In a first step, the plausibility 12 of the respective transfer data of the models is checked by linking the individual body parts with one another. The transfer data of the P model reveal that only one person has been recognized (P=1). An inconsistency of the data results from the H model since the defined body model specifies a left and a right hand as a rule, expressed by e.g. H(L)+H(R)=true. However, H(L)+H(R)=false results from the transfer data. If a left hand is recognized, a right hand should likewise be present. Consequently, in particular the transfer data of the H model must be subjected to a further, second plausibility check 13. In the second plausibility check 13, a linking of the H model with the P model shows that the P model recognized the 3D landmark of a left wrist and a left arm with a certainty of 90% in each case. The results are linked, for example, by checking how the positions of the body model 3D landmarks should be arranged spatially relative to one another according to the body model, wherein the defined body model is adapted to the respective pose or shows it. If, for example, in the pose, if the body model 3D landmarks of the shoulder, elbow, wrist and hip are arranged extending along a substantially straight line in the adapted body model, the hand is very likely to be in the trouser pocket and cannot be recognized. Thus, based on the linking of the respective body model 3D landmarks, the position of the non-recognized hand can be reliably predicted. In a further step, the data link module outputs the validated (true) body model 3D landmarks (3D-LM) of the person 6 or the persons 6. Based on this, a safety response of the machine 1 is triggered in a further step by outputting a control command to the safety controller 7 of the machine 1. The safety response can be derived, for example, from the distance between the recognized left hand and the moving part of the machine 10, as shown in FIG. 1.

FIG. 4 shows the processing chain and the associated sequences in the embodiment of the apparatus with two safety sensors 4 from different viewing angles A, B in each case, wherein the safety sensors 4 detect two persons 6 in the working zone of a machine 3. If two or more safety sensors 4 are used, a respective model can be responsible for recognizing a relevant body part for a respective one image 2 of a safety sensor 4, as shown in FIG. 5, or, alternatively thereto, the image 2 of a first safety sensor 4 and then the image 2 of a second safety sensor 4 can be alternately processed by the models. The image 2 recorded by the first safety sensor 4 from the side view of the working zone 3 (viewing direction A) corresponds to the image 2 of the person 6 I and II shown in FIG. 2b and the image 2 recorded from the plan view of the working zone 3 (viewing direction B) corresponds to the image 2 of the person 6 I and II shown in FIG. 2b. As shown in FIG. 4, the images 2 are input into two mutually separate processing channels of the processing chain. Mutually separate processing channels of the processing chain are characterized in that they evaluate the images 2 from only one safety sensor perspective. In the present case, a respective P, H and F model evaluates the images 2 of a perspective A of a first safety sensor 4 and a perspective B of a second safety sensor 4 separately from one another.

In the embodiment shown in FIG. 4, the first 12 and second 13 plausibility checks, which are shown separately in FIG. 3, of the transfer data for the image 2 are drawn combined from a respective perspective A, B in a box 12, 13. The evaluation of the image 2 by the H model from the viewing angle A results in a right hand and a left hand (#H(A)=H(R, L)). The evaluation by the P model results in two persons (#P=2) and the further 3D landmarks such as arms, wrists of the respective persons I, II. Thus, the result of the H model must e.g. be checked by the further body model 3D landmarks recognized by the P model. The further plausibility check 13, i.e. the linking of the respective transfer data of the H and P model (logic (P(A), #H(A)), provides a meaningful result for the left hand of the person I as described for FIG. 3, but not for the right hand of the person II, so that the result of the second plausibility check #H(A, P=II)=false remains. Similarly thereto, in the case shown in FIG. 4, #H(B, P=I)=false is also transferred for the perspective B because the left hand of the person I 6 is not recognized here. The results are based on the fact that, as indicated in the sketches of FIG. 2a, b, in both perspectives A, B, one hand is concealed by the other person 6 I, II. In a third plausibility check 14, which is shown outlined by a further box in the processing chain shown in FIG. 4, the results of the first 12 and second 13 plausibility checks are linked with one another, and indeed according to the respective pose which the defined body model shows for this case. In the case described here, the transfer data of the perspective A provide the missing coordinates of the right hand of the person I 6, i.e. H(B, P=I, L) results from H(A, P=I, L) and H(A, P=II, R) results from H(B, P=II, R). Thus, the result of the model evaluations is validated. The linking of the respective perspectives A, B in a further plausibility check III increases the prediction reliability of the processing chain and thus the reliability of the apparatus for safeguarding the working zone 3 of the machine 1. The result in step iii) is transferred in the form of representative (true) body model 3D landmarks of the relevant body parts per person after a further evaluation as a control command to a safety controller 7 of the machine 1. The evaluation can consist of calculating the distance of one or more relevant body parts from the moving machine part 10 and, based on this, outputting a control command appropriate for the respective body part, e.g. its biomechanics, speed, etc. The processing chain shown in FIG. 4 further comprises a person recognition model. In the embodiment shown in FIG. 4, the person recognition model is shown as preceding the other models in the processing chain. However, the person recognition model can also be part of the model for recognizing a body posture. In other words, the selected representation of the architecture is only intended to illustrate the sequence of the person recognition. Furthermore, two models for person recognition are shown in FIG. 4. This should not be understood as a restriction to two models, but can equally take place by a single model. For this purpose, the images of the respective perspectives A, B can e.g. be successively recognized by the person recognition model. The person recognition model transfers the number of the persons 6 recognized in image 2 to the data link module of the processing chain so that the number of persons is, for example, available as a transfer parameter for one of the plausibility checks 12, 13, 14 in the data link module. In the embodiment shown in FIG. 4, the person recognition model is configured as a vision transformer model, such as “OWL-ViT”. The model can therefore extract and recognize information from an input context. In other words, the transformer architecture enables OWL-ViT to work with image-text pairs and to recognize objects in images that are not explicitly included in the training dataset. If, for example, a relevant body part cannot be assigned after the plausibility checks, it is possible in the embodiment shown in FIG. 4 that the relevant body part is searched for again and specifically on the input images 2 for a respective perspective A, B by an input text that can be generated in an automated manner based on the result of the plausibility checks. This possibility of a search iteration is schematically indicated by the arrows, shown by dashed lines, from the end of the processing chain to the person recognition model, wherein the arrows are additionally provided with the command text “Find . . . hand” or “Find relevant body part (RB)”. The search iteration further advantageously improves the prediction quality of the processing chain.

In FIG. 5, the working zone 3 of a machine 1 with two persons 6 is shown schematically from a side view. The side view corresponds to the viewing angle A from which the safety sensor 4, A records an image of the working zone 3. In the embodiment shown in FIG. 5, the working zone 3 is optically detected by a total of two safety sensors 4. Two persons 6, I, II are sketched in the working zone 3. The hands of the persons 6, I, II are marked by black rectangular areas, which is supposed to represent the respective bounding boxes 16 of the model for hand recognition (H model). A bounding box 16 outlines the hand recognized by the model in each case. The bounding boxes 16 can be part of the transfer data of a respective model. In FIG. 5, the abbreviation H(I, A, L) is intended to indicate a left hand of the person 6, I recognized by the model from the perspective A. Accordingly, the abbreviation F(I, A, Fr) is intended to indicate the face of the person I recognized by the model, i.e. their front side from the perspective A, and the abbreviation F(I, A, Re) is intended to indicate their rear side. The person I stretches both arms 11 towards the machine 1. The person II merely stretches their left arm 11 towards the machine 1. The right arm 11 of the person II is not visible through the upper body of the person I. However, the right hand of the person II H(II, A, R) is detected by the hand recognition model. The zones of the person I, II are shown in FIG. 5 superimposed by a first hatched box and a second hatched box. The respective boxes are intended to indicate the zones that were automatically marked as person zones by a person recognition model for the person I or II. The recognition of relevant body parts and the body posture of a respective person 6 is restricted to these person zones, which advantageously limits the computing effort.

The side view shown in FIG. 5 is schematically shown in FIG. 6 and is supplemented by the poses of the person I, II recognized by the model for recognizing a body posture, wherein a respective pose is shown by a continuous line. In the embodiment shown, the body posture model did not recognize the concealed right arm of the person II drawn by dashed lines. The model likewise assigns the right arm of the person I to the person II. In this case, the first plausibility check I 12 would already output an error value since the landmarks of the pose of the right arm of both persons I, II match. A comparison with the transfer data of the hand model would probably not lead to a plausibility check from the side view shown in FIG. 6, but only to a linking of the different perspectives A, B of the two safety sensors 4. The different perspectives A, B are calibrated by the QR codes 15 sketched in FIG. 6 so that the coordinates of the images 2 recorded from the perspectives A, B by the safety sensors 4 substantially correspond.

FIG. 7 shows a body model defined for a safety application. The body model has a plurality of marking points 16 that refer to 3D landmarks and that are to be recognized by the respective models. In this respect, by recognizing the landmarks marked 1 to 3, the model can determine a face and thus the front side of a person 6. In comparison thereto, the landmarks 4, 5 and 7, for example, refer to the rear side of a person 6. Thus, it is possible to distinguish between a front side and a rear side of a person 6 in the working zone 3 of a machine 1 based on the recognized 3D landmarks. This distinction advantageously makes it possible that the safety response of the machine 1 to a front side or rear side of a person 6 takes place in a differentiated manner. For example, if a person 6 stands with their back to the machine 1, they can move their arms 11 less easily in the direction of the machine 1 than if they stand with their front side in front of the machine 1. Equally, the model advantageously allows a differentiated safety response depending on whether an arm (3D landmark 16) or a fingertip (3D landmark 18) is recognized. The models for recognizing the relevant body parts, just like the model for recognizing the body posture, have a plurality of further 3D landmarks, wherein these 3D landmarks can comprise those of the differentiated body model. In a preferred embodiment, further 3D landmarks can be marked on the provided differentiated body model by a user of the apparatus by means of a user interface. In one embodiment, the user interface is connected to the edge device via a graphical interface, for example via a cell phone. The body model 3D landmarks shown in FIG. 7 are linked to the 3D landmarks. This can take place by transfer learning or by a linking step. The link can be performed by a neural network that is trained to map the 3D landmarks of a model for body part recognition or the model for recognizing the body posture to the body model 3D landmarks specified in the defined body model. The body model shown in FIG. 7 shows the positions of the body model 3D landmarks in a specific pose in which the relevant body parts are indicated by straight-line connections of the landmarks. This results in a specific mapping rule for this pose. For example, the arrangement of the arms, hands and legs is substantially symmetrical to a vertical line that divides the body into two areas of substantially equal size. A rule derived from this could be that H(L=−H(R). Different mapping rules result depending on the pose. The distances of the body model 3D landmarks can additionally be adapted to biological measurements, such as the length of the arms, legs, etc. FIG. 8 shows the 3D landmarks H1-H20 of a left hand that are recognized by the model for hand recognition to determine the position of the hand in space. The 3D landmark H1 would therefore be identified by the body model 3D landmark 15 and H20, the position of the thumb, by 21 in FIG. 7. Thus, the orientation of the hand is unambiguously predefined by the defined body model.

FIG. 9 shows the body model of a first person I, 6 determined from the body model 3D landmarks of the transfer data and the left arm 11 of a second person II, 6 in a specific pose. The pose predefines a distance between the body part 3D landmarks of the elbow 14 and the hip 24. Thus, the right arm can be reliably assigned to the person I and not the partly depicted arm to the person II. Furthermore, the landmarks 18, 20 and 22 cannot be detected by the model for hand recognition so that the connecting lines in FIG. 9 are indicated with a thinner dashed line than the other body parts of the person I. The distances between the landmark 16 and the landmarks 18, 20 and 22 can be seen from the body model as the length of the connecting lines between the landmarks. The landmark 16 positions the wrist in space and thereby likewise assigns a position in space to the further landmarks. The assignment shows that the landmark 22 is, for example, located within the distance R that is indicated by a dotted circle in FIG. 9. This corresponds to an expected zone 19 within which the landmark is reliably located.

### REFERENCE NUMERAL LIST

1 machine
2 image
3 working zone
4 safety sensor
5 body model
6 person
7 safety controller
8 control unit
9 object
10 moving machine part
11 arm
12 plausibility check I
13 plausibility check II
14 plausibility check III
15 QR code
16 marking points
17 bounding box
18 A, B=perspectives
19 expected zone
20 apparatus
21 protected field

1. An apparatus for detecting a zone of a machine and for forming a protected field in the zone, said apparatus having at least one safety sensor and a control unit, wherein the control unit has a first and a second safety function, wherein
the first safety function is designed as a protected field adaptation and the second safety function is designed as an object tracking,
wherein
the second safety function performs the object tracking of at least one person based on a body model differentiated by body model 3D landmarks, and
the first safety function dynamically adapts a protected field based on data of the second safety function, and
the first safety function generates a control command for monitoring the protected field and outputs said control command to a safety controller of the machine as soon as a body part of the body model enters the protected field.

2. The apparatus according to claim 1, wherein the data of the second safety function comprise spatial positions of the body parts of the at least one person.

3. The apparatus according to claim 1, wherein the protected field is determined by a distance R permitted for a respective body part between the body part and a machine section.

4. The apparatus according to claim 1, having a housing, wherein the at least one safety sensor and the control unit are arranged within the housing.

5. The apparatus according to claim 1, wherein the body model comprises body parts relevant for a safety application, and the second safety function has a processing chain that comprises models based on neural networks for recognizing 3D landmarks of body parts, wherein
in each case at least one model of the processing chain is configured to recognize the 3D landmarks of a relevant body part, of the body parts relevant for the safety application, and at least one model is configured to recognize a body posture.

6. The apparatus according to claim 1, wherein the 3D landmarks of body parts that are recognized by the models are associated with the body model 3D landmarks of the relevant body parts of the body model and are transferred as transfer data to a data link module of the processing chain.

7. The apparatus according to claim 6, wherein the data link module checks the associated body model 3D landmarks of the transfer data for plausibility and completeness based on the body model, and wherein body model 3D landmarks of the body model that are not recognized by the models are concluded based on the checked body model 3D landmarks in order to complete the recognition of the body model 3D landmarks of the body model.

8. The apparatus according to claim 7, wherein, in a first link, the transfer data of the respective at least one model configured to recognize 3D landmarks of a relevant body part are linked to one another within the respective model, and wherein, in a second link, the transfer data of the respective models configured to recognize 3D landmarks of the relevant body parts are linked to one another across the models.

9. The apparatus according to claim 1, wherein the model for recognizing the body posture is configured to also at least partly recognize the body model 3D landmarks of the body parts relevant for the safety application.

10. The apparatus according to claim 1, wherein at least one model of the models is configured to differentiate between a front side and rear side of a person based on the body model.

11. The apparatus according to claim 1, wherein at least one model of the models is configured, based on the body model, to recognize hands as relevant body parts of the body parts relevant for the safety application, and at least one model is configured to recognize faces as relevant body parts of the body parts relevant for the safety application.

12. The apparatus according to claim 1, wherein at least one model of the models is configured to delineate a zone of the at least one person as a person zone in the input image.

13. The apparatus according to claim 1, wherein the differentiated body model comprises anthropometric data.

14. The apparatus according to claim 1, wherein the models for recognizing a relevant body part of the body parts relevant for the safety application are pre-trained and the selection of further training data is representative of the specific application in which the apparatus is used.

15. A method for safeguarding a machine comprising the following steps:
detecting a zone of the machine by means of at least one safety sensor;
forming a protected field in the zone in that a control unit performs a protected field adaptation as a first safety function and performs an object tracking as a second safety function, wherein
the second safety function performs the object tracking of at least one person based on a body model differentiated by body model 3D landmarks, and
the first safety function dynamically adapts the protected field based on data of the second safety function, and
the first safety function generates a control command for monitoring the protected field and outputs said control command to a safety controller of the machine as soon as a body part of the body model enters the protected field.

16. The apparatus in accordance with claim 1, wherein the at least one safety sensor is a camera.

17. The apparatus in accordance with claim 16, wherein the camera is an RGBD camera.

18. The apparatus according to claim 2, wherein the data of the second safety function comprise spatial positions of the body parts relevant for the safety application.

19. The apparatus according to claim 3, wherein the machine section is a movable machine section.

20. The apparatus according to claim 13, wherein the differentiated body model comprises anthropometric data of the relevant body parts.

21. The apparatus according to claim 13, wherein the differentiated body model comprises anthropometric data according to DIN 33402-2:2005-12.
